(19) United States
(12) Patent Application Publication
(10) Pub. No.: US 2004/0241098 A1
(43) Pub. Date: Dec. 2, 2004

(54) Fungicidal mixture containing arylamidine derivatives

(76) Inventors: Gilbert Labourdette, le Monial (FR); Jean-Luc Zundel, Lyon (FR); Anne-Gabrielle Lappartient, Lyon (FR); Alain Villier, Saint Didier au Mont d'Or (FR); Elizabeth O'Neill, Caluire (FR); Jean-Pierre Vors, Lyon (FR); Marie-Claire Grosjean-Cournoyer, Curis au Mont d'Or (FR)

Correspondence Address: OSTROLENK FABER GERB & SOFFEN, 1180 AVENUE OF THE AMERICAS, NEW YORK, NY, 100368403

(21) Appl. No.: 10/489,151

(22) PCT Filed: Sep. 9, 2002
(86) PCT No.: PCT/FR02/03049

(30) Foreign Application Priority Data
Sep. 10, 2001 (FR) 0111685

(51) Int. Cl. A61L 9/02

(52) U.S. Cl. 424/40

(57) ABSTRACT

The present invention relates to a fungicidal composition comprising at least one N₂-phenylamidine derivative in combination with at least one known fungicidal compound, and a method for protecting plants against fungal diseases using such a composition.

The present invention relates to combinations of fungicidal compounds intended in particular for protecting crops against fungal diseases, and the corresponding methods of protection by application of the said combinations.

More precisely, the subject of the present invention is novel fungicidal compositions based on N₂-phenylamidine derivatives and at least one other antifungal agent.

As regards fungicidal activity, in particular for the protection of crops, one of the problems at the heart of the research studies carried out in this technical field is the improvement of performances, in particular in terms of fungicidal activity and in particular in terms of maintaining this fungicidal activity over time.

Naturally, the fungicidal compounds useful for the protection of plants against fungi must be endowed with an ecotoxicity which is reduced to the minimum. As far as possible, they should not be dangerous or toxic to the operator during use.

Furthermore, it is advantageous for fungicidal compounds to have a broad activity spectrum.

The economic factor should of course not be overlooked in the search for novel fungicidal compounds.

Without being limiting, attention is paid more particularly in the context of the invention to protection against infestation, by fungi, of cereals, grapevine, vegetables, lucerne, soyabean, market garden crops, turf, wood and horticultural plants, among others.

The compositions according to the invention include one or more N₂-phenylamidine derivatives as described in international patent application WO-00/46184.

These compounds are englobed within the family defined in this application which covers several thousands of compounds and some form part of the list of more than 700 compounds explicitly mentioned in the document WO-00/46184. As indicated on page 10, lines 16 to 27, the N₂-phenylamidine derivatives of formula (I) according to the document WO-00/46184, may be incorporated into plant-protection compositions with agriculturally acceptable carriers or diluents and optionally one or more active ingredients, such as for example fungicidal compounds. This reference to the use of fungicides with the N₂-phenylamidine compounds of formula (I) has an extremely general scope. The fungicidal active ingredients which may be used with the compounds of formula (I) are not at all explicitly described in the form of isolated compounds or in terms of a chemical family. In particular, no high-performing combination in terms of perennial fungicidal activity is disclosed in this international patent application.

One of the essential objectives of the present invention is to provide novel fungicidal products which can be used, in particular by the farmer, for controlling the fungi infesting crops and in particular for controlling 3 major fungal diseases of cereals, namely: odium, brown rust and Septoria disease.

Another essential objective of the invention is to provide a novel fungicidal composition based on N₂-phenylamidine derivatives which is a lot more active against fungi which are harmful to plants, and which is in particular active over longer periods than the antifungal agents known up until now.

Another essential objective of the invention is to provide a novel fungicidal compound which is completely high-performing in particular as regards its efficacy against fungi and the perenniality of this efficacy so as to be able to reduce the doses of chemical products spread in the environment for combating fungal attacks of crops.

Another essential objective of the invention is to provide a novel fungicidal composition which is more active and active for longer, and which therefore has a lower dose, but which is also less toxic.

Another essential objective of the invention is to provide a novel broad-spectrum fungicidal composition which is perennially effective and which offers the farm a large number of products so that the latter finds among them the product best suited to his particular use.

Another essential objective of the invention is to provide a novel fungicidal composition satisfying the specifications aimed at in the above objectives and which is also of a lower cost price, which is easy and which is not dangerous to handle.

Another essential objective of the invention is to provide a novel fungicidal composition as defined in the above objectives and which is useful in the preventive and curative treatment of fungal diseases, for example, of cereals, Solanaceae, grapevine, vegetables, lucerne, soyabean, market garden crops, turf, wood or horticultural plants.

Another essential objective of the invention is to provide a novel fungicidal composition exhibiting an improved efficacy against Basidiomycetes and Ascomycetes.

Another essential objective of the invention is to provide a preventive and/or curative treatment of plants and in particular of crops, using a fungicidal composition or a fungicidal combination combining the products of the composition as defined in the above objectives, it being necessary for such a treatment to have a high and perennial efficacy against a very wide variety of fungi, while minimizing the doses, the toxicity and the cost.

Another essential objective of the present invention is to provide a kit for controlling, by way of curing and/or preventing and/or eradicating, the phytopathogenic fungi of plants and in particular of crops, which meets the specifications set out in the objectives above.

An additional objective of the present invention is to allow improvement in the yield of the crops which is significant from an agronomic point of view.

All these objectives, among others, were achieved by the inventors who have had the merit of finding a fungicidal combination between N₂-phenylamidine derivatives and a known fungicidal compound, for example of the triazole, triazolinone, amidazole, strobilurin or morpholine type; such a combination surprisingly and unexpectedly exhibiting a very high and perennial antifungal efficacy against a broad spectrum of fungi and in particular against those responsible for diseases of cereals such as Basidiomycetes or Ascomycetes.

The present invention, which completely or partially satisfies the abovementioned objectives, therefore relates firstly to fungicidal compositions comprising:

A) at least one arylamidine derivative of formula (I):

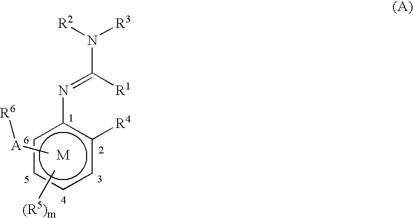

in which:

R¹ is an alkyl, an alkenyl, an alkynyl, a carbocyclic or heterocyclic monovalent group, it being possible for each of these groups to be substituted, or hydrogen

R² and R³, which may be identical or different, are any one of the groups defined for R¹; a cyano; an acyl; —OR^{a} or —SR^{a}, with R^{a} corresponding to an alkyl, an alkenyl, an alkynyl, a carbocyclic or heterocyclic monovalent group, it being possible for each of these groups to be substituted, or R² and R³, or R² and R¹ may form together and with the atoms linking them, a ring which may be substituted;

R⁴ is an alkyl, an alkenyl, an alkynyl, a carbocyclic or heterocyclic monovalent group, it being possible for each of these groups to be substituted, a hydroxyl group; mercapto; azido; nitro; halo; cyano; optionally substituted acyl, amino; cyanato; thiocyanato; —SF₅; —OR^{a}; —SR^{a} or —Si(R^{a})₃;

m=0 to 3;

the optional R⁵ group or the optional R⁵ groups, which may be mutually identical or different, have the same definition as that given above for R⁴;

R⁶ is optionally substituted with a carbocyclic monovalent group; and

A is a direct bond, —O—, —S(O)ₙ—, —NR⁹—, —CR⁷═CR⁷—, —C≡—C—, -A¹-, -A¹-A¹, —O-(A¹)ₖ-O—, —O-(A¹)ₖ-, -A³-, -A⁴-, -A¹O—, -A¹S(O)ₙ—, -A²-, OA²-, —NR⁹A²-, —OA²-A¹-, —OA²-C(R⁷)═C(R⁸)—, —S(O)ₙA¹-, -A¹-A⁴-, -A¹-A⁴-C(R⁸)═N—N═CR⁸—, -A¹-A⁴-C(R⁸)═N—X²—X³—, -A¹-A⁴-A³-, -A¹-A⁴-N(R⁹)—, -A¹-A⁴-X—CH₂-, -A¹-A⁴-A¹—, -A¹-A⁴-CH₂X—, -A¹-A⁴-C(R⁸)═N—X²—X³—X¹—, -A¹-X—C(R⁸)═N—, -A¹-X—C(R⁸)═N—N═CR⁸—, -A¹-X—C(R⁸)═N—N(R⁹)—, -A¹-X-A⁻-X¹—, -A¹-O-A³-, -A¹-O—C(R⁷)═C(R⁸)—, -A¹-O—N(R⁹)-A²-N(R⁹)—, -A¹-O—N(R⁹)-A²-, -A¹-N(R⁹)-A²-N(R⁹)—, -A¹-N(R⁹)-A²-, -A¹-N(R⁹)—N═C(R⁸)—, -A³-A¹-, -A⁴-A³-, -A²-NR⁹—, -A¹-A²-X¹—, -A¹-A¹-A²-X¹—, —O-A²-N(R⁹)-A²-, —CR⁷═CR⁷-A²-X¹—, —C≡C-A²-X¹—, —N═C(R⁸)-A²-X¹—, —C(R⁸)═N—N═C(R⁸)—, —C(R⁸)═N—N(R⁹)—, —(CH₂)₂—O—N═C(R⁸)— or —X-A²-N(R⁹)—

with

n=0, 1 or 2,

k=1 to 9,

A¹=—CHR⁷—,

A²=—C(═X)—,

A³=—C(R⁸)═N—O—,

A⁴=—O—N═C(R⁸)—,

X=O or S,

X¹=O, S, NR⁹ or a direct bond,

X²=O, NR⁹ or a direct bond,

X³=hydrogen, —C(═O)—, —SO₂— or a direct bond,

R⁷, which are mutually identical or different, each correspond to an optionally substituted alkyl, to a cycloalkyl or a phenyl, it being possible for each of these groups to be substituted, hydrogen, a halogen, a cyano, or an acyl;

R⁸, which are mutually identical or different, each correspond to an alkyl, an alkenyl, an alkynyl, an alkoxy, an alkylthio, it being possible for each of these groups to be substituted, a carbocyclic or heterocyclic monovalent group which may be optionally substituted, or hydrogen;

R⁹, which are mutually identical or different, each correspond to an optionally substituted alkyl, to a monovalent carbocyclic or heterocyclic group which may be optionally substituted, or to an acyl; or two R⁹ groups may form together, and with the atoms linking them, a 5-7-membered ring;

the group represented on the right side of the bond A is linked to R⁶; or -A-R⁶ and R⁵ form together with the benzene ring M, a system of optionally substituted condensed rings;

and the optional optical and/or geometric isomers, the tautomers and the addition salts with an acid or a base, which are agriculturally acceptable, of these derivatives of formula (I); and mixtures thereof; and

B) at least one other known fungicidal compound, preferably chosen from the group comprising: triazoles, triazolinones, imidazoles, strobilurins and morpholines, their optional optical and/or geometric isomers, their tautomers and the addition salts with an acid or a base, which are agriculturally acceptable, and mixtures thereof

In the definitions of the compounds of formula (I) set out above, the various radicals and chemical terms used have, unless otherwise stated, the following meanings:

“alkyl or alkyl-” denotes a linear or branched saturated hydrocarbon radical containing from 1 to 8 carbon atoms;

“alkenyl” denotes a linear or branched hydrocarbon radical containing from 1 to 8 carbon atoms and an unsaturation in the form of double bond;

“alkynyl” denotes a linear or branched hydrocarbon radical containing from 1 to 8 carbon atoms and an unsaturation in the form of a triple bond;

“alkoxy” denotes an alkyloxy radical;

“acyle” denotes the formyl radical or an alkoxycarbonyl radical;

“cycloalkyl” denotes a saturated cyclic hydrocarbon radical containing from 3 to 8 carbon atoms;

“aryle” denotes one or more aromatic radicals, preferably a phenyl or a naphthyl;

“heterocycle” denotes an unsaturated or a completely or partially saturated cyclic radical containing from 3 to 8 atoms, chosen from carbon, nitrogen, sulphur and oxygen, for example, and without limitation, pyridyl, pyridinyl, quinolyl, furyl, thienyl, pyrrolyl, oxazolinyl;

the term “optionally substituted” means that the radicals thus termed may be substituted with one or more radicals chosen from chlorine, bromine, fluorine, iodine, alkyl, alkoxy, hydroxyl, nitro, amino; cyano and acyl.

According to a preferred embodiment of the invention, compounds (A) are of formula (I) in which:

R¹ is an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxy, with a haloalkoxy, with an alkylthiol or with a halogen, or hydrogen;

R² and R³ which may be identical or different and which have the same definition as that given above for R¹ or which correspond to an alkoxy, an alkoxyalkyl, a benzyloxy, a cyano or an alkylcarbonyl;

R⁴ is an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxy, with a haloalkoxy, with an alkylthiol or with a halogen; a hydroxyl; a halogen; a cyano; an acyl (preferably: —C(═O)R^{c}, —C(═S)R^{c} or —S(O)ₚR^{c}, with R^{c} corresponding to an alkyl, a haloalkyl, alkoxy, haloalkoxy, alkylthiol, an amine, a monoalkylamine, a dialkylamine or a phenyl optionally substituted with an alkyl, with a haloalkyl, with an alkoxy, with a haloalkoxy, or with an alkylthiol;

m=0 or 1;

when it is present, R⁵ is a group having the same definition as that given above for R⁴,

A is a direct bond, —O—, —S—, —NR⁹—, —CHR⁷— or —O—CHR⁷—,

with R⁹, when it is present, corresponding to an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxyl, with a haloalkoxy, with an alkylthiol or with a halogen, or corresponds to hydrogen;

and R⁷ has the same definition as that given above for R⁹ or represents a hydroxyl; a halogen; a cyano; an acyl; alkoxy; a haloalkoxy or an alkylthiol;

A is linked to the 4-position of the benzyl ring M; and

R⁶ is a phenyl or an aromatic heterocycle, optionally substituted with one or more substituents, which may be identical or different, and which may be selected from the following list: hydroxyl; halogen; cyano; acyl (preferably —C(═O)R^{c}, —C(═S)R^{c} or —S(O)ₚR^{c}, with R^{c}=alkyl, haloalkyl, alkoxy, haloalkoxy, alkylthiol or phenyl optionally substituted with an alkyl, haloalkyl, alkoxy, haloalkoxy or alkylthiol); amine; alkylamine; dialkylamine; alkyl, haloalkyl, R^{a}O-alkyl, acyloxyalkyl, cyanooxyalkyl, alkoxy, haloalkoxy, alkylthiol; cycloalkyl (preferably cyclohexyl or cyclopentyl) optionally substituted with an alkyl, a haloalkyl, an alkoxy, a haloalkoxy or with an alkylthiol; and benzyl optionally substituted with an alkyl, a haloalkyl, an alkoxy, a haloalkoxy or with an alkylthiol.

The compounds (A) of formula (I) which are still more especially preferred are those possessing the following characteristics, taken in isolation or combination:

R¹=H

R²=C1-C6 alkyl, preferably methyl;

R³=C1-C6 alkyl, preferably ethyl;

R⁴=C1-C6 alkyl, preferably methyl;

R⁵=C1-C6 alkyl, preferably methyl and R⁵ is linked to the carbon at C5 of the benzyl ring M, with m=1;

A is linked to the carbon at C4 of the benzyl ring M and represents —O—;

R⁶=aryl, preferably benzyl, advantageously substituted with at least one alkyl and/or with at least one halogen.

By way of example, the compounds (A) used in the fungicidal composition according to the invention are preferred:

N-ethyl-N-methyl-N′-[4-(chloro-3-trifluoromethylphenoxy)-2,5-xylyl]-formamidine,

and N-ethyl-N-methyl-N′-[4-(fluoro-3-trifluoromethylphenoxy)-2,5-xylyl]-formamidine

and the possible tautomers and addition salts with an acid or a base, which are agriculturally acceptable, of these compounds (A).

These particular compounds (A) are not among those tested as fungicides in international patent application WO-00/46184.

The compounds (B) which are advantageously and inventively combined with the compounds (A) defined above are preferably those selected from the following list of fungicides:

phenylmercuric acetate; Ampelomyces quisqualis; ac 382042; azaconazole; azoxystrobin; acibenzolar-s-methyl, Bacillus subtilis; benalaxyl; benomyl; biphenyl; bitertanol; blasticidin-s; Bordeaux mixture; borax; bromuconazole; bupirimate; calboxin; calcium polysulphide; captafol; captan; carbendazim; carboxin, carpropamid (ktu 3616); cga 279202; chinomethionat; chlorothalonil; chlozolinate; fungicidal compositions based on copper or copper derivatives such as copper hydroxide; copper naphthenate; copper oxychloride; copper sulphate; copper oxide; cymoxanil; cyproconazole; cyprodinil; cyazofamid, dazomet; debacarb; dichlofluanid; dichlomezine; dichlorophen; diclocymet; dicloran; diethofencarb; difenoconazole; difenzoquat; difenzoquat metilsulphate; diflumetorim; dimethirimol; dimethomorph; dimoxystrobin, diniconazole; diniconazole-m; dinobuton; dinocap; diphenylamine; discostrobin, dithianon; dodemorph; dodemorph acetate; dodine; dodine free base; edifenphos; epoxiconazole (bas 480f); elhaboxam; ethasulfocarb; ethirimol; etridiazole; famoxadone; fenamidone; fenarimol; fenbuconazole; fenfin; fenfuram; fenhexamid; fenpiclonil; fenpropidin; fenpropimorph; fentin acetate; fentin hydroxide; ferbam; ferimzone; fluazinam; fludioxonil; fluoroimide; fluquinconazole; flusilazole; flusulfamide; flutolanil; flumetover, flutriafol; folpet; formaldehyde; fosetyl; fosetyl-aluminium; fuberidazole; furalaxyl; Fusarium oxysporum; furametpyr; 8-hydroxyquinoline sulphate; Gliocladium virens; guazatine; guazatine acetate; gy-81; hexachlorobenzene; hexaconazole; hymexazol; potassium hydroxyquinoline sulphate; icia 0858; ikf-916; imazalil; imazalil sulphate; imibenconazole; iprobenphos; iminoctadine; iminoctadine triacetate; iminoctadine tris[albesilate]; ipconazole; iprobenfos; iprodione; iprovalicarb; isoprothiolane; kasugamycin; kasugamycin hydrochloride hydrate; kresoxim-methyl; mancopper; mancozeb; maneb; mefenoxame; mepanipyrim; mepronil; mercury(II) chloride; mercury(II) oxide; mercury(I) chloride; metalaxyl and its enantiomers, in particular metalaxyl-m; metam; metam-sodium; metconazole; methasulfocarb; methyl isothiocyanate; metiram; metiram-zinc; metominostrobin (ssf-126); mon65500; myclotbutanil; nabam; naphthenic acid; zinc naphthenate; natamycin; nickel bis(dimethyldithiocarbamate); nitrothal-isopropyl; nuarimol; octhilinone; ofurace; oleic acid (fatty acids); oxadixyl; oxine-copper; oxycarboxin; penconazole; pencycuron; pentachlorophenol; pentachlorophenyl laurate; perfurazoate; 2-phenylphenol; Phlebiopsis gigantea; phosphoric acid and its derivatives such as fosetyl-al, phthalide; picoxystrobin; piperalin; polyoxine b; polyoxines; polyoxorim; probenazole; prochloraz; procymidone; propamocarb; propamocarb hydrochloride; propiconazole; propineb; pyraclostrobin; pyrazophos; pyributicarb; pyrifenox; pyrimethanil; pyroquilon; quinoxyfen; quintozene; rh-7281; sec-butylamine; sodium 2-phenylphenoxide; sodium pentachlorophenoxide; silthiofam, simeconazole, spiroxamine (kwg 4168); Streptomyces griseoviridis; sulphur; tar oils; tebuconazole; tecnazene; tetraconazole; thiabendazole; thifluzamide; thiophanate such as thiophanate-methyl; thiram; tolclofos-methyl; tolylfluanid; triadimefon; triadimenol; trifloxystrobin; triazolopyrimidines, in particular methyl cloransulam, flumetsulam, florasulam, metosulam, triazoxide; Trichoderma harzianum; tricyclazole; tridemorph; trifloxystrobin; triflumizole; triforine; triticonazole; validamycin; valinamide derivatives, in particular iprovalicarb and benthiavalicarb; vinclozolin; zineb; ziram; zenoxamide and mixtures thereof.

Fluquinconazole and fenpropimorph and their possible tautomers and addition salts with an acid or a base, which are agriculturally acceptable, are more particularly preferred; the same applies for the compounds (B) of the family of strobilurins.

For more details on these selected compounds (B) according to the invention, reference will be made for example to “The Pesticide Manual”, 11th edition, C D S Tomlin, British Crop Protection Council, pages 1015-1017, No. 599.

The fungicidal combination of compounds (A) with compounds (B) according to the invention, in particular fluquinconazole and fenpropimorph, makes it possible to significantly improve the persistence of antifungal activity in the context of the curative and/or preventive treatment of major disease of cereals such as oidium, brown rust and Septoria disease. This combination has eradicant properties which are superior to those of the products alone.

As is evident from the preceding text, the preferred examples of fungicidal combinations according to the invention will comprise compound (A) and fluquinconazole and/or fenpropimorph, and their possible tautomers and addition salts with an acid or a base, provided that these equivalents are acceptable in the agricultural field.

From the point of view of weight, it should be specified that in accordance with the invention, the mass ratio (A/B) is defined as follows:

0.001≦A/B≦500

preferably 0.01≦A/B≦500

and still more preferably 0.01≦A/B≦10.

In the case where compound (B) is fluquinconazole or fenpropimorph (or one of their equivalents), it has been found that the mass ratio (A/B) is advantageously between 0.05 and 5.

The compound (A)/compound (B) ratio is defined as being the ratio by weight of these 2 compounds. The same applies to any ratio of 2 chemical compounds, which is subsequently measured in the present text, since a definition different from this ratio is not expressly given.

According to another aspect of the present invention, in the compositions according to the invention, the compound (A)/compound (B) ratio may be advantageously chosen so as to produce a synergistic effect. The term synergistic effect is understood to mean in particular that defined by Colby in an article entitled “Calculation of the synergistic and antagonistic responses of herbicide combinations” Weeds, (1967), 15, pages 20-22.

The latter article mentions the formula:

$$E = X + Y - \frac{X Y}{100}$$

in which E represents the expected percentage of inhibition of the disease for the combination of the two fungicides at defined doses (for example equal to x and y respectively), X is the percentage of inhibition observed for the disease by the compound (A) at a defined dose (equal to x), Y is the percentage of inhibition observed for the disease by the compound (B) at a defined dose (equal to y). When the percentage of inhibition observed for the combination is greater than E, there is a synergistic effect.

The term “synergistic effect” also means the effect defined by application of the Tammes method, “Isoboles, a graphic representation of synergism in pesticides”, Netherlands Journal of Plant Pathology, 70(1964), pages 73-80.

The compound (A)/compound (B) ratio ranges indicated above do not in any way limit the scope of the invention, but are, rather, mentioned as a guide, a person skilled in the art being entirely capable of carrying out additional tests to find other values of the ratio of doses of these two compounds, for which a synergistic effect is observed.

Usually, the compositions according to the invention comprise between 0.00001 and 100%, preferably between 0.001 and 80%, of active compounds, whether these compounds are combined, or whether they are in the form of two active ingredients used separately.

Naturally, the fungicidal compositions according to the invention based on at least one compound (A) and on at least one compound (B) may also comprise one or more other active products chosen from fungicides, herbicides, insecticides and/or plant growth regulators, according to the use for which they are intended.

In addition to these additional active agents, the fungicidal compositions according to the invention may also contain any other excipient and/or auxiliary agent useful in plant protection formulations such as, for example, an agriculturally suitable inert carrier and optionally an agriculturally suitable surfactant.

As regards the presentations of the compositions according to the invention, it should be indicated that they are appropriate for a large number of formulations. Thus, it is possible to use these compositions as aerosol dispenser; bait (ready-to-use); concentrate for preparation of baits; stock bait; suspension of capsules; cold fogging concentrate; dustable powder; emulsifiable concentrate; aqueous/aqueous type emulsion; oil/inverse type emulsion; encapsulated granule; fine granule; suspension concentrate for seed treatment; compressed gas; gas generating product; grain bait; granular bait; granule; hot fogging concentrate; macrogranule; microgranule; oil-dispersible powder, oil miscible suspension concentrate; oil-miscible liquid; paste; plant rodlet; plate bait; powder for dry seed treatment; scrap bait; seeds coated with a pesticide; smoke candle; smoke cartridge; smoke generator; smoke pellet; smoke rodlet; smoke tablet; smoke tin; soluble concentrate; soluble powder; solution for seed treatment; suspension concentrate (=flowable concentrate); tracking powder; ultra low volume liquid; ultra low volume suspension; vapour releasing product; water-dispersible granules or tablets; water dispersible powder for slurry treatment; water-soluble granules or tablets; water-soluble powder for seed treatment; wettable powder.

These compositions cover not only the compositions which are ready to be applied to the crop by means of a suitable device, such as a spraying device, but also the commercial concentrated compositions which have to be diluted before application to the crop.

The compositions described below are used in general for application to growing plants, or to sites where crops are grown, or for the coating or film-coating of seeds.

The compositions according to the invention are, appropriately, applied to the vegetation and in particular to the leaves infested or capable of being infested with the phytopathogehic fungi. Another method of applying the compounds or compositions according to the invention is to add a formulation containing the active ingredients to the irrigation water. This irrigation may be an irrigation using sprinklers.

For their use in practice, the compositions according to the invention can be used alone and can also advantageously be used in formulations containing one or the other of the active ingredients or alternatively both of them together, in combination or association with one or more other compatible components which are, for example, solid or liquid fillers or diluents, adjuvants, surfactants or equivalents, which are suitable for the desired use and which are acceptable for uses in agriculture. The formulations can be of any type known in the sector which are suitable for application onto all types of plantations or crops. These formulations, which can be prepared in any manner known in this sector, also form part of the invention.

The formulations can also contain ingredients of other types, such as protective colloids, adhesives, thickeners, thixotropic agents, penetrating agents, oils for spraying, stabilizers, preserving agents (in particular mouldproofing agents), sequestering agents or the like, as well as other known active ingredients which have pesticidal properties (in particular fungicidal, insecticidal, acaricidal or nematocidal properties) or which have properties of regulating plant growth. More generally, the compounds used in the invention can be combined with any solid or liquid additives corresponding to the usual formulation techniques.

In the present account, the term “filler” means an organic or inorganic, natural or synthetic component with which the active components are combined to facilitate its application, for example, onto the plants, the seeds or the soil. This filler is consequently generally inert and it must be acceptable (for example acceptable for agronomic uses, in particular for treating plants).

The filler can be solid, for example clays, natural or synthetic silicates, silica, resins, waxes, solid fertilizers (for example ammonium salts), natural soil minerals, such as kaolins, clays, talc, lime, quartz, attapulgite, montmorillonite, bentonite or diatomaceous earths, or synthetic minerals, such as silica, alumina or silicates, in particular aluminium or magnesium silicates. The solid fillers which are suitable for granules are as follows: natural, crushed or broken rocks, such as calcite, marble, pumice, sepiolite and dolomite; synthetic granules of inorganic or organic flours; granules of organic material such as sawdust, coconut shell, corn ear or envelope, or tobacco stem; kieselguhr, tricalcium phosphate, powdered cork or adsorbent carbon black; water-soluble polymers, resins, waxes; or solid fertilizers. Such compositions can, if so desired, contain one or more compatible agents such as wetting agents, dispersing agents, emulsifiers or colourings which, when they are solid, can also act as diluents.

The fillers can also be liquid, for example: water, alcohols, in particular butanol or glycol, as well as ethers or esters thereof, in particular methyl glycol acetate; ketones, in particular acetone, cyclohexanone, methyl ethyl ketone, methyl isobutyl ketone or isophorone; petroleum fractions such as paraffinic or aromatic hydrocarbons, in particular xylenes or alkylnaphthalenes; mineral or plant oils; aliphatic chlorohydrocarbons, in particular trichloroethane or methylene chloride; aromatic chlorohydrocarbons, in particular chlorobenzenes; water-soluble or highly polar solvents such as dimethylformamide, dimethyl sulphoxide, N,N-dimethyl-acetamide or N-methylpyrrolidone; N-octylpyrrolidone, liquefied gases; or the like, whether they are taken separately or as a mixture.

The surfactant can be an emulsifier, a dispersing agent or a wetting agent, of ionic or nonionic type or a mixture of these surfactants. Among those surfactants there are used, for example, polyacrylic acid salts, lignosulphonic acid salts, phenolsulphonic or naphthalenesulphonic acid salts, polycondensates of ethylene oxide with fatty alcohols or fatty acids or fatty esters or fatty amines, substituted phenols (in particular alkylphenols or arylphenols), ester-salts of sulphosuccinic acid, taurine derivatives (in particular alkyl taurates), phosphoric esters of alcohols or of polycondensates of ethylene oxide with phenols, fatty acid esters with polyols, or sulphate, sulphonate or phosphate functional derivatives of the compounds described above. The presence of at least one surfactant is generally essential when the active ingredients and/or the inert filler are insoluble or only sparingly soluble in water and when the filler for the said composition to be applied is water.

The formulations according to the invention can also contain other additives such as adhesives or colourings. Adhesives such as carboxymethylcellulose, or natural or synthetic polymers in the form of powders, granules or matrices, such as gum arabic, latex, polyvinylpyrrolidone, polyvinyl alcohol or polyvinyl acetate, natural phospholipids, such as cephalins or lecithins, or synthetic phospholipids can be used in the formulations. It is possible to use colourings such as inorganic pigments, such as, for example: iron oxides, titanium oxides, Prussian blue; organic colouringstuffs, such as those of the alizarin, azo or metal phthalocyanin type; or of trace elements such as iron, manganese, boron, copper, cobalt, molybdenum or zinc salts.

The formulations containing the compositions of the invention, which are used to control the phytopathogenic fungi of crops, can also contain stabilizers, other fungicidal agents, insecticides, acaricides, nematicides, anti-helminths or anti-coccidoses, bactericides, attractant or repellent agents, deodorizers, flavourings or colourings.

These can be chosen for the purpose of improving the strength, the persistence, the safety, and the spectrum of action on the phytopathogenic fungi of crops or to make the composition capable of accomplishing other useful functions for the areas treated.

For their use in agriculture, the compositions according to the invention are consequently formulated in various solid or liquid forms.

As solid formulations, there may be mentioned dustable powders (with a content of active ingredients which may be up to 100%) and granules, in particular those obtained by extrusion, spray-drying, compacting, impregnation of a granulated support, granulation from a powder (the content of active ingredients in these granules being between 0.5 and 80% for the latter cases).

The fungicidal compositions according to the invention may also be used in the form of dustable powders; it is also possible to use formulations comprising 50 g of active ingredients and 950 g of talc; it is also possible to use formulations comprising 20 g of active ingredients, 10 g of finely divided silica and 970 g of talc; these constituents are mixed and ground and the mixture is applied by dusting.

As liquid formulations or formulations intended to constitute liquid compositions during application, there may be mentioned solutions, in particular water-soluble concentrates, emulsifiable concentrates, emulsions, suspension concentrates, wettable powders (or spraying powder).

The suspension concentrates, which can be applied by spraying, are prepared so as to obtain a stable fluid product which does not sediment and which leads to good bioavailability of the active ingredients. These suspensions usually contain from 5% to 75% of active ingredients, preferably from 10% to 25%, from 0.5 to 75% of surfactants, preferably from 5% to 50%, from 0 to 10% of appropriate additives, such as thickening agents of organic or inorganic origin, antifoaming agents, corrosion inhibitors, adhesives, preservatives, such as for example Proxel GXL®, antifreezes and, as carrier, water or an organic liquid in which the active ingredients are sparingly soluble or are insoluble: certain organic solid substances or inorganic salts may be dissolved in the carrier in order to help prevent sedimentation or as antifreezes for water. In some cases, and in particular for formulations intended for the treatment of seeds, one or more colourings may be added.

For foliar applications, the choice of surfactants is crucial to ensure good bioavailability of the active ingredients; thus a combination of a surfactant with a hydrophilic character (HLB>10) and of a surfactant with a lipophilic character (HLB<5) will be preferably used. Such combinations of surfactants are, for example, described in French patent application No. 00 04015, which is not yet published.

As regards the preparation of compounds (A), reference may be made to international Patent Application WO-00/46184.

As regards the production of compounds (B), reference may be made to the book “The Electronic Pecticide Manual—Version 1.0”—British Crop Protection Council—Ed Clive Tomlin.

According to another of these objects, the invention relates to a method for controlling, by way of curing, preventing or eradicating, the phytopathogenic fungi of crops, characterized in that an effective (agronomically effective) and nonphytotoxic quantity of a fungicidal composition as defined above is applied to the soil where plants grow or are capable of growing, to the leaves and/or the fruits of plants or to the seeds of plants.

In this method, a composition is used which is prepared beforehand by mixing the 2 active compounds (A) and (B).

According to a variant of such a method of controlling, by way of curing, preventing or eradicating, the phytopathogenic fungi of crops:

a combination of at least one compound (A) and of at least one compound (B) as defined above is used;

the compounds (A) and (B) are applied simultaneously, separately or sequentially to the soil where plants grow or are capable of growing, to the leaves and/or the fruits of plants or to the seeds of plants, an effective (agronomically effective) and nonphytotoxic quantity.

This variant corresponds to a fresh preparation of the fungicidal composition.

It is also possible to apply simultaneously, successively or separately so as to have the conjugated (A)/(B) effect, of a composition each containing one of the two active ingredients (A) or (B).

Preferably, the fungicidal compositions according to the invention usually contain from 0.5 to 95% of the combination of compound (A) and compound (B). This may be the concentrated composition, that is to say the commercial product combining compound (A) and compound (B). This may also be the dilute composition ready to be applied to the crops to be treated. In the latter case, the dilution with water may be carried out either using a commercial concentrated composition containing compound (A) and compound (B) (this mixture is called ready mix), or using the tank mix of two commercial concentrated compositions each containing compound (A) and compound (B).

The treatment of crops against phytopathogenic diseases, using the fungicidal composition according to the invention, is carried out, for example, by application or by administration, with an effective and nonphytotoxic quantity of the abovementioned fungicidal composition or combination, to the aerial parts of the crops or to the soil where they grow, the said crops being those which are infested or which are capable of being infested by a phytopathogenic disease such as oidium, brown rust or Septoria disease. The expression treatment of the crop is also understood to mean the treatment of the reproductive products of the crop, such as the seeds or the tubers for example.

Advantageously, the quantity of fungicidal composition or combination corresponds to a dose of compound (A) and of compound (B) of between about 1 g/ha and about 2 000 g/ha, preferably between 1 g/has and 1 000 g/ha.

Under specific conditions, for example according to the nature of the phytopathogenic fungus to be treated, a lower dose may offer adequate protection. Conversely, certain climatic conditions, resistance or other factors may require higher doses of active ingredient.

The effective working doses of the combinations used in the invention can vary within wide proportions, in particular depending on the nature of the phytopathogenic fungi to be eliminated or the degree of infestation, for example, of the plants with these fungi.

The optimum dose usually depends on several factors, for example on the type of phytopathogenic fungus to be treated, on the type or level of development of the infested plant, on the density of vegetation, or alternatively on the method of application. More preferably, an effective dose of active ingredients (A) and (B) is between about 5 g/ha and about 700 g/ha.

Without it being limiting, the crop treated with the fungicidal composition or combination according to the invention is, for example, a cereal, but this could be grapevine, vegetables, lucerne, soyabean, market garden crops, turf, wood or horticultural plants.

The phytopathogenic fungi of crops which may be controlled by this method are selected from the group comprising:

the group of oomycetes:

of the genus Phytophthora such as Phytophthora phaseoli, Phytophthora citrophthora, Phytophthora capsici, Phytophthora cactorum, Phytophthora palmivora, Phytophthora cinnamoni, Phytophthora megasperma, Phytophthora parasitica, Phytophthora fragariae, Phytophthora cryptogea, Phytophthora porri, Phytophthora nicotianae, Phytophthora infestans (mildew of Solanaceae, in particular late blight of potato or tomato);

of the family of Peronosporaceae, in particular Plasmopara viticola (vine downy mildew), Plasmopara halstedei (sunflower mildew), Pseudoperonospora sp (in particular cucurbit mildew (Pseudoperonospora cubensis) and downy mildew of hops (Pseudoperonospora humuli)), Bremia lactucae (mildew of lettuce), Peronospora tabacinae (downy mildew of tobacco), Peronospora destructor (downy mildew of onion), Peronospora parasitica (downy mildew of cabbage), Peronospora farinosa (downy mildew of chicory and downy mildew of beetroot);

the group of adelomycetes (ascomycetes):

of the genus Alternaria, for example Alternaria solani (early blight of Solanaceae and in particular of tomato and potato),

of the genus Guignardia, in particular Guignardia bidwelli (black rot of grapevine),

of the genus Venturia, for example Venturia inaequalis, Venturia pirina (apple or pear scabs),

of the genus Oidium, for example powdery mildew of grapevine (Uncinula necator); oidium of leguminous crops, for example Erysiphe polygoni (powdery mildew of Cruciferae); Leveillula taurica, Erysiphe cichoracearum, Sphaerotheca fuligena (powdery mildew of cucurbits, of composites and of tomato); Erysiphe communis (powdery mildew of beetroot and cabbage); Erysiphe pisi (powdery mildew of pea and lucerne); Erysiphe polyphaga (powdery mildew of haricot bean and cucumber); Erysiphe umbelliferarum (powdery mildew of ombellifera, in particular of carrot); Sphaerotheca humuli (hop mildew); powdery mildew of wheat and barley (Erysiphe graminis forma specie tritici and Erysiphe graminis forma specie hordei),

of the genus Taphrina, for example Taphrina deformans (peach leaf curl),

of the genus Septoria, for example Septoria nodorum or Septoria tritici (Septoria disease of cereals),

of the genus Sclerotinia, for example Sclerotinia sclerotinium,

of the genus Pseudocercosporella, for example P. herpotrichoides (eyespot of cereals),

of the genus Botrytis cinerea (grapevine, vegetable and market garden crops, pea and the like),

of the genus Phomopsis viticola (excoriosis of grapevine),

of the genus Pyrenospora,

of the genus Helminthosporium, for example Helminthosporium tritici repentis (yellow leaf spot of wheat) or Helminthosporium teres (yellow leaf spot of barley),

of the genus Drechslera or Pyrenophora,

of the group of basidiomycetes:

of the genus Puccinia, for example Puccinia recondita or striiformis (wheat rust), Puccinia triticina, Puccinia hordei,

of the family Rhizoctonia spp, for example Rhizoctonia solani.

In addition to their fungicidal activities at the heart of the invention, the compositions or combinations defined above may also have a biocide action against bacteria and viruses, such as for example:

fire blight, Erwinia amylovora;

bacterial streak of stone fruit trees, Xanthomonas campestris;

pear blossom blight, Pseudomonas syringae;

bacteriosis of rice and cereals;

the viruses present on rice, vegetable and cereal crops.

The crops envisaged in the context of the present invention are preferable cereal crops (wheat, barley, maize, rice) and vegetable crops (haricot bean, onion, cucurbitaceae, cabbage, potato, tomato, sweet pepper, cabbage, pea, lettuce, celery, chicory), fruit crops (strawberry plants, raspberry plants), tree crops (apple trees, pear trees, cherry trees, ginseng, lemon trees, coconut palms, pecan trees, cacao trees, walnut trees, rubber trees, olive trees, poplars, banana trees), grapevine, sunflower, beetroot, tobacco and ornamental crops.

A classification made, no longer based on the fungi or bacteria targeted, but on the target crops may be illustrated as below:

grapevine: powdery mildew (Uncinula necator), downy mildew (Plasmopara viticola), grey mould (Botrytis cinerea), excoriosis (Phomopsis viticola) and black rot (Guignardia bidwelli),

Solanaceae: blight (Phytophthora infestans), alternara disease (Alternaria solani) and grey mould (Botrytis cinerea),

vegetable crops: downy mildew (Peronospora sp., Bremia lactucae, Pseudoperonospora sp), alternara (Alternaria sp.), sclerotinia disease (Sclerotinia sp.), grey mould (Botrytis cinerea), foot or root rot (Rhizoctonia spp.), powdery mildew (Erysiphe sp.; Sphaerotheca fuliginea),

arboriculture: scab (Venturia inaequalis, V. pirina), bacterial diseases (erwinia amylovora, xanthomonas campestris, pseudomonas syringae), powdery mildew (Podosphaera leucotricha) and Monilia (Monilia fructigena),

citrus: scab (Elsinoe fawcetti), melanose (Phomopsis citri) and Phytophthora sp. diseases,

wheat, as regards controlling the following seed diseases: Fusarium diseases (Microdochium nivale and Fusarium roseum), smuts (Tilletia caries, Tilletia controversa or Tilletia indica), Septoria disease (Septoria nodorum),

wheat, as regards controlling the following diseases of the aerial parts of the plant: eyespot (Pseudocercosporella herpotrichoïdes), take-all (Gaeumannomyces graminis), Fusarium disease of the foot (F. culmorum, F. graminearum), Rhizoctonia disease (Rhizoctonia cerealis), powdery mildew (Erysiphe graminis forma specie tritici), rusts (Puccinia striiformis and: Puccinia recondita), Septoria diseases (Septoria tritici and Septoria nodorum) and yellow leaf spot of wheat (Helminthosporium tritici-vulgaris),

wheat and barley, as regards controlling bacterial and viral diseases, for example barley yellow mosaic,

barley, as regards controlling the following seed diseases: yellow leaf spot (Pyrenophora graminea, Bipolaris, Pyrenophora teres and Cochliobolus sativus), loose smut (Ustilago nuda) and Fusarium diseases (Microdochium nivale and Fusarium roseum),

barley, as regards controlling the following diseases of the aerial parts of the plant: eyespot (Pseudocercosporella herpotrichoïdes), yellow leaf spot (Pyrenophora teres and Cochliobolus sativus), powdery mildew (Erysiphe graminis forma specie hordei), dwarf leaf rust (Puccinia hordei) and leaf blotch (Rhynchosporium secalis);

potato, as regards controlling tuber diseases (in particular Helminthosporium solani, Phoma tuberosa, Rhizoctonia solani, Fusarium solani) and certain virus diseases (virus Y);

cotton, as regards controlling the following diseases of young plants obtained from seeds: damping-off diseases and collar rot (Rhizoctonia solani, Fusarium oxysporum), black root rot (Thielaviopsis basicola),

pea, as regards controlling the following seed diseases: anthracnose (Ascochyta pisi, Mycosphaerella pinodes), Fusarium disease (Fusarium oxysporum), grey mould (Botrytis cinerea), rust (Uromyces pisi),

rape plant, as regards controlling the following seed diseases: Phoma lingam and Alternaria brassicae, grey mould (Botrytis cinerea), and sclérotinia disease (Sclérotinia sclerotinium),

maize, as regards controlling seed diseases (Rhizopus sp., Penicillium sp., Trichoderma sp., Aspergillus sp. and Gibberella fiijikuroï), yellow leaf spot (Bipolaris), Fusarium disease (Fusarium oxysporum),

rice: foot and root rot (Rhizoctonia spp.),

flax, as regards controlling seed disease (Alternaria linicola),

banana: Cercospora disease (Mycosphaerella figiensis),

turf: rust, powdery mildew, yellow leaf spot, terruric diseases (Microdochium nivale, Pythium sp., Rhizoctonia solani, Sclerotinia homeocarpa),

forest trees, as regards controlling damping-off (Fusarium oxysporum, Rhizoctonia solani).

Very advantageously, the method for controlling plant diseases according to the invention has shown excellent results against cereal diseases such as powdery mildew, Septoria disease and brown rust.

The expression “are applied to the plants to be treated” is understood to mean, for the purposes of the present text, that the fungicidal compositions which are the subject of the invention may be applied by means of various methods of treatment such as:

spraying onto the aerial parts of the said plants a liquid comprising one of the said compositions,

dusting, the incorporation into the soil of granules or powders, spraying, around the said plants, and in the case of trees injection or daubing,

coating or film-coating the seeds of the said plants with the aid of a plant-protection mixture comprising one of the said compositions.

Spraying a liquid onto the aerial parts of the crops to be treated is the preferred method of treatment.

The subject of the present invention is also a product comprising a compound (A) of formula (I) and a compound (B) as a combined preparation for simultaneous, separate or sequential use in controlling the phytopathogenic fungi of crops at a site.

Another object of the invention which is linked to the mode of preparing the composition according to the invention immediately before use consists of a kit for controlling, curatively or preventively, the phytopathogenic fungi of crops, characterized in that it comprises at least one compound (A) of formula (I) and at least one compound (B) as defined above, intended to be combined or used simultaneously, separately or sequentially in controlling the phytopathogenic fungi of crops at a site.

It is therefore a pack in which the user finds all the ingredients for preparing the fungicidal formulation which they wish to apply to the crops. These ingredients, which comprise in particular the active agents (A) and (B) and which are packaged separately, are provided in the form of a powder or in the form of a liquid which is concentrated to a greater or lesser degree. The user simply has to mix in the prescribed doses and to add the quantities of liquid, for example of water, necessary to obtain a formulation which is ready to use and which can be applied to the crops.

Most appropriate is a product for simultaneous, separate, alternate or sequential application of at least one fungicidal compound (A) of formula (I) and one fungicidal compound (B).

The following examples are given purely by way of illustration of the invention and do not limit it in any manner.

### EXAMPLES

They are intended to give an illustration of the efficacy of the compositions according to the invention on cereal diseases, in particular the compositions combining compound (A), having the chemical name N-ethyl-N-methyl-N′-[4-(chloro-3-trifluoromethylphénoxy)-2,5-xylyl]formamidine, with fungicidal compounds of the triazole and morpholine type. The trials on cereals were carried out in an open field.

### 1—Conditions and Objectives

The objective of these field trials is therefore to test the efficacy of compounds (A) of formula (I), in particular N-ethyl-N-methyl-N′-[4-(chloro-3-trifluoromethylphenoxy)-2,5-xylyl]formamidine, alone at 125 g/ha and combined with 2 fungicides which are commercially available: fluquinconazole (100 g/ha) and fenpropimorph (750 g/ha) representing 2 classes of fungicidal compounds. Powdery mildew, brush rust and Septoria disease mycosphaerella graminicola (Septoria tritici) are the principal diseases treated.

### 2—Materials and Methods

The products tested are therefore

N-ethyl-N-methyl-N′-[4-(chloro-3-trifluorométhylphénoxy)-2,5-xylyl]-formamidine as compound (A) at 125 g/ha as an EC type formulation at 100 g/l,

fluquinconazole as compound (B) at 100 g/ha as a formulation at 100 g/l,

fenpropimorph as another compound (B) at 750 g/ha at 750 g/l,

compound (A) and fluquinconazole combination at 125+100 g/ha as a fresh preparation,

compound (A) and fenpropimorph combination at 125+750 g/ha, also as a fresh preparation,

the reference products which are azoxystrobin at 250 g/ha on brown rust and Septoria disease,

epoxyconazole+kresoxim-methyl at 125+125 g/ha on the 3 diseases,

quinoxyfen at 150 g/ha on powdery mildew.

Each trial comprises 3 repeats and untreated control plots are included in the experimental design in order to measure the severity of the diseases.

The experimental conditions are summarized in Table 1 below.

TABLE 1

| | | | Basic | | | Application(s) | |
|---|---|---|---|---|---|---|---|
| | | | surface area | | Sowing | BBCH stage | |
| Country | Trial | Species | per plot | Variety | date | Date | l/ha |
| France | 1 | Wheat | 10 m² | Récital | 20/10/00 | BBCH31 | 260 |
| | | | | | | 23 Mar. 2001 | |
| | | | | | | BBCH37 | |
| | | | | | | 18 Apr. 2001 | |
| Germany | 2 | Wheat | 10 m² | Rialto | 23/10/00 | BBCH30 | 400 |
| | | | | | | 09 Apr. 2001 | |
| | | | | | | BBCH35 | |
| | | | | | | 14 May 2001 | |
| Germany | 3 | Wheat | 10 m² | Ritmo | 23/10/00 | BBCH30 | 400 |
| | | | | | | 09 Apr. 2001 | |

All the trials are conducted under natural contamination conditions. The equipment for application is a constant compressed air pressure back sprayer. The spray nozzles have slits.

The BBCH scale has been described in Compendium of growth stage identification eys for mono- and dicotyledonous plants, extended BBCH scale, Autumn 1994 by Reinold Stauss, Basle, a joint publication of BBA-BSA-IGZ-IVA AgrEvo-BASF-Bayer-Ciba.

The efficacy results are obtained from controls carried out in the field:

by overall evaluation (% infestation)

evaluation of the diseased surface (% of diseased surface) on a sample of 25 leaves

counting the number of sori per leaf on a sample of 25 leaves

counting the infested leaves (% of infested leaves) on a sample of 25 leaves

the results of variance analysis are obtained from a Newman and Keuls test (5%).

### 3—Results

Wheat powdery mildew (Erysiphe graminis)

This result is measured 59 days after the application of the products onto wheat.

Quinoxyfen, at the limit of persistence, still retains a low but significant efficacy.

Fluquinconazole and fenpropimorph no longer have an activity.

The combinations according to the invention have a better persistence of activity than the references or the active ingredients used alone.

Septoria tritici (Mycosphaerella graminicola)

This result is measured 29 days after the second application.

The combinations according to the invention have a better persistence of activity than the references azoxystrobin and epoxyconazole+kresoxim-methyl, or than the active ingredients used alone.

Brown rust (Puccinia recondita)

This result is measured 29 days after the second application.

The combinations according to the invention again have a better persistence of activity than the active ingredients used alone.

Moreover, the mixture according to the invention with fluquinconazole possesses superior eridacant properties on brown rust than that of the products alone (visual observation following a control carried out 13 days after a treatment).

### 4—Conclusion

The various results obtained in the open field demonstrate that compound (A), which is not very persistent by itself, makes it possible significantly improve the persistence of activity of compounds (B) fluquinconazole and fenpropimorph on 3 major cereal diseases: powdery mildew, brown rust and Septoria disease. This better persistence of the combinations according to the invention makes it possible to obtian efficacy levels close to or higher than the market references.

1. Fungicidal composition comprising:
A) at least one arylamidine derivative of formula (I): 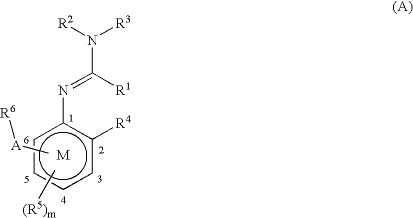
in which:
R¹ is an alkyl, an alkenyl, an alkynyl, a carbocyclic or heterocyclic monovalent group, it being possible for each of these groups to be substituted, or hydrogen
R² and R³, which may be identical or different, are any one of the groups defined for R¹; a cyano; an acyl; —OR^{a} or —SR^{a}, with R^{a} corresponding to an alkyl, an alkenyl, an alkynyl, a carbocyclic or heterocyclic monovalent group, it being possible for each of these groups to be substituted, or R² and R³, or R² and R¹ may form together and with the atoms linking them, a ring which may be substituted;
R⁴ is an alkyl, an alkenyl, an alkynyl, a carbocyclic or heterocyclic monovalent group, it being possible for each of these groups to be substituted, a hydroxyl group; mercapto; azido; nitro; halo; cyano; optionally substituted acyl, amino; cyanato; thiocyanato; —SF₅; —OR^{a}; —SR^{a} or —Si(R^{a})₃;
m=0 to 3;
the optional R⁵ group or the optional R⁵ groups, which may be mutually identical or different, have the same definition as that given above for R⁴;
R⁶ is optionally substituted with a carbocyclic monovalent group; and
A is a direct bond, —O—, —S(O)ₙ—, —NR⁹—, —CR⁷═CR⁷—, —C≡C—, -A¹-, -A¹-A¹, —O-(A¹)ₖ-O—, —O-(A¹)ₖ-O—, -A³-, -A⁴-, -A¹O—, -A¹S(O)ₙ—, -A²-, OA²-, —NR⁹A²-, —OA²-A¹-, —OA²-C(R⁷)═C(R⁸)—, —S(O)ₙA¹-, -A¹-A⁴-, -A¹-A⁴-C(R⁸)═N—N═CR⁸—, -A¹-A⁴-C(R⁸)═N—X²—X³—, -A¹-A⁴-A³-, -A¹-A⁴-N(R⁹)—, -A¹-A⁴-X—CH₂—, -A¹-A⁴-A¹-, -A¹-A⁴-CH₂X—, -A¹-A⁴-C(R⁸)═N—X²—X³—X¹—, -A¹-X—C(R⁸)═N—, -A¹-X—C(R⁸)═N—N═CR⁸—, -A¹-X—C(R⁸)═N—N(R⁹)—, -A¹-X-A⁻-X¹—, -A¹-O-A³-, -A¹-O—C(R⁷)═C(R⁸)—, -A¹-O—N(R⁹)-A²-N(R⁹)—, -A¹-O—N(R⁹)-A²-, -A¹-N(R⁹)-A²-N(R⁹)—, -A¹-N(R⁹)-A²-, -A¹-N(R⁹)—N═C(R⁸)—, -A³-A¹-, -A⁴-A³-, -A²-NR⁹—, -A¹-A²-X¹—, -A¹-A¹-A²-X¹—, —O-A²-N(R⁹)-A²-, —CR⁷═CR⁷-A²-X¹—, —C≡C-A²-X¹—, —N═C(R⁸)-A²-X¹—, —C(R⁸)═N—N═C(R⁸)—, —C(R⁸)═N—N(R⁹)—, —(CH₂)₂—O—N═C(R⁸)— or —X-A²-N(R⁹)—
with
n=0, 1 or 2,
k=1 to 9,
A¹=—CHR⁷—,
A²=—C(═X)—,
A³=—C(R⁸)═N—O—,
A⁴=—O—N═C(R⁸)—,
X=O or S,
X¹=O, S, NR⁹ or a direct bond,
X²=O, NR⁹ or a direct bond,
X³=hydrogen, —C(═O)—, —SO₂— or a direct bond,
R⁷, which are mutually identical or different, each correspond to an optionally substituted alkyl, to a cycloalkyl or a phenyl, it being possible for each of these groups to be substituted, hydrogen, a halogen, a cyano, or an acyl;
R⁸, which are mutually identical or different, each correspond to an alkyl, an alkenyl, an alkynyl, an alkoxy, an alkylthio, it being possible for each of these groups to be substituted, a carbocyclic or heterocyclic monovalent group which may be optionally substituted, or hydrogen;
R⁹, which are mutually identical or different, each correspond to an optionally substituted alkyl, to a monovalent carbocyclic or heterocyclic group which may be optionally substituted, or to an acyl; or two R⁹ groups may form together, and with the atoms linking them, a 5-7-membered ring;
the group represented on the right side of the bond A is linked to R⁶; or -A-R⁶ and R⁵ form together with the benzene ring M, a system of optionally substituted condensed rings;
and the optional optical and/or geometric isomers, the tautomers and the addition salts with an acid or a base, which are agriculturally acceptable, of these derivatives of formula (I); and mixtures thereof; and
B) at least one other known fungicidal compound, preferably chosen from the group comprising: triazoles, triazolinones, imidazoles, strobilurins and morpholines, their optional optical and/or geometric isomers, their tautomers and the addition salts with an acid or a base, which are agriculturally acceptable, and mixtures thereof.

2. Composition according to claim 1, such that the compound (A) is the formula (I) in which:
R¹ is an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxy, with a haloalkoxy, with an alkylthiol or with a halogen, or hydrogen;
R² and R³ which may be identical or different and which have the same definition as that given above for R¹ or which correspond to an alkoxy, an alkoxyalkyl, a benzyloxy, a cyano or an alkylcarbonyl;
R⁴ is an alkyl, an alkenyl or an alkynyl, it being possible for each of these groups to be substituted with alkoxy, a haloalkoxy, an alkylthiol, halogen or a phenyl optionally substituted with an alkyl, with a haloalkyl, with an alkoxy, with a haloalkoxy, with an alkylthiol or with a halogen; a hydroxyl; an halogen; a cyano; an acyl (preferably: —C(═O)R^{c}, —C(═S)R^{c} or —S(O)ₚR^{c}, with R^{c} corresponding to an alkyl, a haloalkyl, alkoxy, haloalkoxy, alkylthiol, an amine, a monoalkylamine, a dialkylamrine or a phenyl optionally substituted with an alkyl, with a haloalkyl, with an alkoxy, with a haloalkoxy, or with an alkylthiol;
m=0 or 1;
when it is present, R⁵ is a group having the same definition as that given above for R⁴,
A is a direct bond, —O—, —S—, —NR⁹—, —CHR⁷— or —O—CHR⁷—,
with R⁹, when it is present, corresponding to an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxy, with a haloalkoxy, with an alkylthiol or with a halogen, or corresponds to hydrogen;
and R⁷ has the same definition as that given above for R⁹ or represents a hydroxyl; a halogen; a cyano; an acyl; alkoxy; a haloalkoxy or an alkylthiol;
A is linked to the 4-position of the benzyl ring M; and
R⁶ is a phenyl or an aromatic heterocycle, optionally substituted with one or more substituents, which may be identical or different, and which may be selected from the following list: hydroxyl; halogen; cyano; acyl (preferably —C(═O)R^{c}, —C(═S)R^{c} or —S(O)ₚR^{c}, with R^{c}=alkyl, haloalkyl, alkoxy, haloalkoxy, alkylthiol or phenyl optionally substituted with an alkyl, haloalkyl, alkoxy, haloalkoxy or alkylthiol); amine; alkylamine; dialkylamine; alkyl, haloalkyl, R^{a}O-alkyl, acyloxyalkyl, cyanooxyalkyl, alkoxy; haloalkoxy; alkylthiol; cycloalkyl (preferably cyclohexyl or cyclopentyl) optionally substituted with an alkyl, a haloalkyl, an alkoxy, a haloalkoxy or with an alkylthiol; and benzyl optionally substituted with an alkyl, a haloalkyl, an alkoxy, a haloalkoxy or with an alkylthiol.

3. Composition according to claim 1, such that the compound (A) of formula (I) possesses the following characteristics, taken in isolation or combination:
R¹=H
R²=C1-C6 alkyl preferably methyl;
R³=C1-C6 alkyl, preferably ethyl;
R⁴=C1-C6 alkyl, preferably methyl;
R⁵=C1-C6 alkyl, preferably methyl and R⁵ is linked to the carbon at C5 of the benzyl ring M, with m=1;
A is linked to the carbon at C4 of the benzyl ring M and represents —O—;
R⁶=aryl, preferably benzyl, advantageously substituted with at least one alkyl and/or with at least one halogen.

4. Composition according to claim 1, such that the compound (A) is -N-ethyl-N-methyl-N′-[4-(chloro-3-trifluoromethylphenoxy)-2,5-xylyl]-formamidine or and N-ethyl-N-methyl-N′-[4-(fluoro-3-trifluoromethylphenoxy)-2,5-xylyl]-formamidine and the possible tautomers and addition salts with an acid or a base, which are agriculturally acceptable.

5. Composition according to claim 1, such that the compound (B) is selected from phenylmercuric acetate; Ampelomyces quisqualis; ac 382042; azaconazole; azoxystrobin; acibenzolar-s-methyl, Bacillus subtilis; benalaxyl; benomyl; biphenyl; bitertanol; blasticidin-s; Bordeaux mixture; borax; bromuconazole; bupirimate; calboxin; calcium polysulphide; captafol; captan; carbendazim; carboxin, carpropamid (ktu 3616); cga 279202; chinomethionat; chlorothalonil; chlozolinate; fungicidal compositions based on copper or copper derivatives such as copper hydroxide; copper naphthenate; copper oxychloride; copper sulphate; copper oxide; cymoxanil; cyproconazole; cyprodinil; cyazofamid, dazomet; debacarb; dichlofluanid; dichlomezine; dichlorophen; diclocymet; dicloran; diethofencarb; difenoconazole; difenzoquat; difenzoquat metilsulphate; diflumetorim; dimethirimol; dimethomorph; dimoxystrobin, diniconazole; diniconazole-m; dinobuton; dinocap; diphenylamine; discostrobin, dithianon; dodemorph; dodemorph acetate; dodine; dodine free base; edifenphos; epoxiconazole (bas 480f); ethaboxam; ethasulfocarb; ethirimol; etridiazole; famoxadone; fenamidone; fenarimol; fenbuconazole; fenfin; fenfuram; fenhexamid; fenpiclonil; fenpropidin; fenpropimorph; fentin acetate; fentin hydroxide; ferbam; ferimzone; fluazinam; fludioxonil; fluoroimide; fluquinconazole; flusilazole; flusulfamide; flutolanil; flumetover, flutriafol; folpet; formaldehyde; fosetyl; fosetyl-aluminium; fuberidazole; furalaxyl; Fusarium oxysporum; furametpyr; 8-hydroxyquinoline sulphate; Gliocladium virens; guazatine; guazatine acetate; gy-81; hexachlorobenzene; hexaconazole; hymexazol; potassium hydroxyquinoline sulphate; icia 0858; ikf-916; imazalil; imazalil sulphate; imibenconazole; iprobenphos; iminoctadine; iminoctadine triacetate; iminoctadine tris[albesilate]; ipconazole; iprobenfos; iprodione; iprovalicarb; isoprothiolane; kasugamycin; kasugamycin hydrochloride hydrate; kresoxim-methyl; mancopper; mancozeb; maneb; mefenoxame; mepanipyrim; mepronil; mercury(II) chloride; mercury(II) oxide; mercury(I) chloride; metalaxyl and its enantiomers, in particular metalaxyl-m; metam; metam-sodium; metconazole; methasulfocarb; methyl isothiocyanate; metiram; metiram-zinc; metominostrobin (ssf-126); mon65500; myclotbutanil; nabam; naphthenic acid; zinc naphthenate; natamycin; nickel bis(dimethyldithiocarbamate); nitrothal-( isopropyl; nuarimol; octhilinone; ofurace; oleic acid (fatty acids); oxadixyl; oxine-copper; oxycarboxin; penconazole; pencycuron; pentachlorophenol; pentachlorophenyl laurate; perfurazoate; 2-phenylphenol; Phlebiopsis gigantea; phosphoric acid and its derivatives such as fosetyl-al, phthalide; picoxystrobin; piperalin; polyoxine b; polyoxines; polyoxorim; probenazole; prochloraz; procymidone; propamocarb; propamocarb hydrochloride; propiconazole; propineb; pyraclostrobin; pyrazophos; pyributicarb; pyrifenox; pyrimethanil; pyroquilon; quinoxyfen; quintozene; rh-7281; sec-butylamine; sodium 2-phenylphenoxide; sodium pentachlorophenoxide; silthiofam, simeconazole, spiroxamine (kwg 4168); Streptomyces griseoviridis; sulphur; tar oils; tebuconazole; tecnazene; tetraconazole; thiabendazole; thifluzamide; thiophanate such as thiophanate-methyl; thiram; tolclofos-methyl; tolylfluanid; triadimefon; triadimenol; trifloxystrobin; triazolopyrimidines, in particular methyl cloransulam, flumetsulam, florasulam, metosulam, triazoxide; Trichoderma harzianum; tricyclazole; tridemorph; trifloxystrobin; triflumizole; triforine; triticonazole; validamycin; valinamide derivatives, in particular iprovalicarb and benthiavalicarb; vinclozolin; zineb; ziram; zenoxamide and mixtures thereof.

6. Composition according to claim 1, such that the mass ratio between the compound (A) and the compound (B) is such that
0.001≦A/B≦500, preferably such that
0.01≦A/B≦500, and still more preferably
0.01≦A/B≦10.

7. Method for controlling, by way of curing, preventing or eradicating, the phytopathogenic fungi of crops, characterized in that an effective (agronomically effective) and nonphytotoxic quantity of a fungicidal composition according to claim 1 is applied to the soil where plants grow or are capable of growing, to the leaves and/or the fruits of plants or to the seeds of plants.

8. Method according to claim 7 for protecting cereal crops (wheat, barley, maize, rice) and vegetable crops (haricot bean, onion, cucurbitaceae, cabbage, potato, tomato, sweet pepper, cabbage, pea, lettuce, celery, chicory), fruit crops (strawberry plants, raspberry plants), tree crops (apple trees, pear trees, cherry trees, ginseng, lemon trees, coconut palms, pecan trees, cacao trees, walnut trees, rubber trees, olive trees, poplars, banana trees), grapevine, sunflower, beetroot, tobacco and ornamental crops, luceme, soyabean, market garden crops, turf, wood or horticultural plants.

9. Method according to claim 7 for controlling cereal diseases such as powdery mildew, Septoria disease and brown rust.

10. Product for the simultaneous, separate, alternate or sequential application of at least one fungicidal compound (A) of formula (I) and a fungicidal compound (B) according to claim 1.

11. Composition according to claim 2, such that the compound (A) of formula (I) possesses the following characteristics, taken in isolation or combination:
R¹=H
R²=C1-C6 alkyl, preferably methyl;
R³=C1-C6 alkyl, preferably ethyl;
R⁴=C1-C6 alkyl, preferably methyl;
R⁵=C1-C6 alkyl, preferably methyl and R⁵ is linked to the carbon at C5 of the benzyl ring M, with m=1;
A is linked to the carbon at C4 of the benzyl ring M and represents —O—;
R⁶=aryl, preferably benzyl, advantageously substituted with at least one alkyl and/or with at least one halogen.

12. Composition according claim 2, such that the compound (A) is -N-ethyl-N-methyl-N′-[4-(chloro-3-trifluoromethylphenoxy)-2,5-xylyl]-formamidine or and N-ethyl-N-methyl-N′-[4-(fluoro-3-trifluoromethylphenoxy)-2,5-xylyl]-formamidine and the possible tautomers and addition salts with an acid or a base, which are agriculturally acceptable.

13. Composition according to claim 3, such that the compound (A) is -N-ethyl-N-methyl-N′-[4-(chloro-3-trifluoromethylphenoxy)-2,5-xylyl]-formamidine or and N-ethyl-N-methyl-N′-[4-(fluoro-3-trifluoromethylphenoxy)-2,5-xylyl]-formamidine and the possible tautomers and addition salts with an acid or a base, which are agriculturally acceptable.

14. Composition according to claim 2, such that the compound (B) is selected from phenylmercuric acetate; Ampelomyces quisqualis; ac 382042; azaconazole; azoxystrobin; acibenzolar-s-methyl, Bacillus subtilis; benalaxyl; benomyl; biphenyl; bitertanol; blasticidin-s; Bordeaux mixture; borax; bromuconazole; bupirimate; calboxin; calcium polysulphide; captafol; captan; carbendazim; carboxin, carpropamid (ktu 3616); cga 279202; chinomethionat; chlorothalonil; chlozolinate; fungicidal compositions based on copper or copper derivatives such as copper hydroxide; copper naphthenate; copper oxychloride; copper sulphate; copper oxide; cymoxanil; cyproconazole; cyprodinil; cyazofamid, dazomet; debacarb; dichlofluanid; dichlomezine; dichlorophen; diclocymet; dicloran; diethofencarb; difenoconazole; difenzoquat; difenzoquat metilsulphate; diflumetorim; dimethirimol; dimethomorph; dimoxystrobin, diniconazole; diniconazole-m; dinobuton; dinocap; diphenylamine; discostrobin, dithianon; dodemorph; dodemorph acetate; dodine; dodine free base; edifenphos; epoxiconazole (bas 480f); ethaboxam; ethasulfocarb; ethirimol; etridiazole; famoxadone; fenamidone; fenarimol; fenbuconazole; fenfin; fenfuram; fenhexamid; fenpiclonil; fenpropidin; fenpropimorph; fentin acetate; fentin hydroxide; ferbam; ferimzone; fluazinam; fludioxonil; fluoroimide; fluquinconazole; flusilazole; flusulfamide; flutolanil; flumetover, flutriafol; folpet; formaldehyde; fosetyl; fosetyl-aluminium; fuberidazole; furalaxyl; Fusarium oxysporum; furametpyr; 8-hydroxyquinoline sulphate; Gliocladium virens; guazatine; guazatine acetate; gy-81; hexachlorobenzene; hexaconazole; hymexazol; potassium hydroxyquinoline sulphate; icia 0858; ikf-916; imazalil; imazalil sulphate; imibenconazole; iprobenphos; iminoctadine; iminoctadine triacetate; iminoctadine tris[albesilate]; ipconazole; iprobenfos; iprodione; iprovalicarb; isoprothiolane; kasugamycin; kasugamycin hydrochloride hydrate; kresoxim-methyl; mancopper; mancozeb; maneb; mefenoxame; mepanipyrim; mepronil; mercury(II) chloride; mercury(II) oxide; mercury(I) chloride; metalaxyl and its enantiomers, in particular metalaxyl-m; metam; metam-sodium; metconazole; methasulfocarb; methyl isothiocyanate; metiram; metiram-zinc; metominostrobin (ssf-126); mon65500; myclotbutanil; nabam; naphthenic acid; zinc naphthenate; natamycin; nickel bis(dimethyldithiocarbamate); nitrothal-isopropyl; nuarimol; octhilinone; ofurace; oleic acid (fatty acids); oxadixyl; oxine-copper; oxycarboxin; penconazole; pencycuron; pentachlorophenol; pentachlorophenyl laurate; perfurazoate; 2-phenylphenol; Phlebiopsis gigantea; phosphoric acid and its derivatives such as fosetyl-al, phthalide; picoxystrobin; piperalin; polyoxine b; polyoxines; polyoxorim; probenazole; prochloraz; procymidone; propamocarb; propamocarb hydrochloride; propiconazole; propineb; pyraclostrobin; pyrazophos; pyributicarb; pyrifenox; pyrimethanil; pyroquilon; quinoxyfen; quintozene; rh-7281; sec-butylamine; sodium 2-phenylphenoxide; sodium pentachlorophenoxide; silthiofam, simeconazole, spiroxamine (kwg 4168); Streptomyces griseoviridis; sulphur; tar oils; tebuconazole; tecnazene; tetraconazole; thiabendazole; thifluzamide; thiophanate such as thiophanate-methyl; thiram; tolclofos-methyl; tolylfluanid; triadimefon; triadimenol; trifloxystrobin; triazolopyrimidines, in particular methyl cloransulam, flumetsulam, florasulam, metosulam, triazoxide; Trichoderma harzianum; tricyclazole; tridemorph; trifloxystrobin; triflumizole; triforine; triticonazole; validamycin; valinamide derivatives, in particular iprovalicarb and benthiavalicarb; vinclozolin; zineb; ziram; zenoxamide and mixtures thereof.

15. Composition according to claim 3, such that the compound (B) is selected from phenylmercuric acetate; Ampelomyces quisqualis; ac 382042; azaconazole; azoxystrobin; acibenzolar-s-methyl, Bacillus subtilis; benalaxyl; benomyl; biphenyl; bitertanol; blasticidin-s; Bordeaux mixture; borax; bromuconazole; bupirimate; calboxin; calcium polysulphide; captafol; captan; carbendazim; carboxin, carpropamid (ktu 3616); cga 279202; chinomethionat; chlorothalonil; chlozolinate; fuingicidal compositions based on copper or copper derivatives such as copper hydroxide; copper naphthenate; copper oxychloride; copper sulphate; copper oxide; cymoxanil; cyproconazole; cyprodinil; cyazofamid, dazomet; debacarb; dichlofluanid; dichlomezine; dichlorophen; diclocymet; dicloran; diethofencarb; difenoconazole; difenzoquat; difenzoquat metilsulphate; diflumetorim; dimethirimol; dimethomorph; dimoxystrobin, diniconazole; diniconazole-m; dinobuton; dinocap; diphenylamine; discostrobin, dithianon; dodemorph; dodemorph acetate; dodine; dodine free base; edifenphos; epoxiconazole (bas 480f); ethaboxam; ethasulfocarb; ethirimol; etridiazole; famoxadone; fenamidone; fenarimol; fenbuconazole; fenfin; fenfuram; fenhexamid; fenpiclonil; fenpropidin; fenpropimorph; fentin acetate; fentin hydroxide; ferbam; ferimzone; fluazinam; fludioxonil; fluoroimide; fluquinconazole; flusilazole; flusulfamide; flutolanil; flumetover, flutriafol; folpet; formaldehyde; fosetyl; fosetyl-aluminium; fuberidazole; furalaxyl; Fusarium oxysporum; furametpyr; 8-hydroxyquinoline sulphate; Gliocladium virens; guazatine; guazatine acetate; gy-81; hexachlorobenzene; hexaconazole; hymexazol; potassium hydroxyquinoline sulphate; icia 0858; ikf-916; imazalil; imazalil sulphate; imibenconazole; iprobenphos; iminoctadine; iminoctadine triacetate; iminoctadine tris[albesilate]; ipconazole; iprobenfos; iprodione; iprovalicarb; isoprothiolane; kasugamycin; kasugamycin hydrochloride hydrate; kresoxim-methyl; mancopper; mancozeb; maneb; mefenoxame; mepanipyrim; mepronil; mercury(II) chloride; mercury(II) oxide; mercury(I) chloride; metalaxyl and its enantiomers, in particular metalaxyl-m; metam; metam-sodium; metconazole; methasulfocarb; methyl isothiocyanate; metiram; metiram-zinc; metominostrobin (ssf-126); mon65500; myclotbutanil; nabam; naphthenic acid; zinc naphthenate; natamycin; nickel bis(dimethyldithiocarbamate); nitrothal-isopropyl; nuarimol; octhilinone; ofurace; oleic acid (fatty acids); oxadixyl; oxine-copper; oxycarboxin; penconazole; pencycuron; pentachlorophenol; pentachlorophenyl laurate; perfurazoate; 2-phenylphenol; Phlebiopsis gigantea; phosphoric acid and its derivatives such as fosetyl-al, phthalide; picoxystrobin; piperalin; polyoxine b; polyoxines; polyoxorim; probenazole; prochloraz; procymidone; propamocarb; propamocarb hydrochloride; propiconazole; propineb; pyraclostrobin; pyrazophos; pyributicarb; pyrifenox; pyrimethanil; pyroquilon; quinoxyfen; quintozene; rh-7281; sec-butylamine; sodium 2-phenylphenoxide; sodium pentachlorophenoxide; silthiofam, simeconazole, spiroxamine (kwg 4168); Streptomyces griseoviridis; sulphur; tar oils; tebuconazole; tecnazene; tetraconazole; thiabendazole; thifluzamide; thiophanate such as thiophanate-methyl; thiram; tolclofos-methyl; tolylfluanid; triadimefon; triadimenol; trifloxystrobin; triazolopyrimidines, in particular methyl cloransulam, flumetsulam, florasulam, metosulam, triazoxide; Trichoderma harzianum; tricyclazole; tridemorph; trifloxystrobin; triflumizole; triforine; triticonazole; validamycin; valinamide derivatives, in particular iprovalicarb and benthiavalicarb; vinclozolin; zineb; ziram; zenoxamide and mixtures thereof.

16. Composition according to claim 4, such that the compound (B) is selected from phenylmercuric acetate; Ampelomyces quisqualis; ac 382042; azaconazole; azoxystrobin; acibenzolar-s-methyl, Bacillus subtilis; benalaxyl; benomyl; biphenyl; bitertanol; blasticidin-s; Bordeaux mixture; borax; bromuconazole; bupirimate; calboxin; calcium polysulphide; captafol; captan; carbendazim; carboxin, carpropamid (ktu 3616); cga 279202; chinomethionat; chlorothalonil; chlozolinate; fungicidal compositions based on copper or copper derivatives such as copper hydroxide; copper naphthenate; copper oxychloride; copper sulphate; copper oxide; cymoxanil; cyproconazole; cyprodinil; cyazofamid, dazomet; debacarb; dichlofluanid; dichlomezine; dichlorophen; diclocymet; dicloran; diethofencarb; difenoconazole; difenzoquat; difenzoquat metilsulphate; diflumetorim; dimethirimol; dimethomorph; dimoxystrobin, diniconazole; diniconazole-m; dinobuton; dinocap; diphenylamine; discostrobin, dithianon; dodemorph; dodemorph acetate; dodine; dodine free base; edifenphos; epoxiconazole (bas 480f); ethaboxam; ethasulfocarb; ethirimol; etridiazole; famoxadone; fenamidone; fenarimol; fenbuconazole; fenfin; fenfuram; fenhexamid; fenpiclonil; fenpropidin; fenpropimorph; fentin acetate; fentin hydroxide; ferbam; ferimzone; fluazinam; fludioxonil; fluoroimide; fluquinconazole; flusilazole; flusulfamide; flutolanil; flumetover, flutriafol; folpet; formaldehyde; fosetyl; fosetyl-aluminium; fuberidazole; furalaxyl; Fusarium oxysporum; furametpyr; 8-hydroxyquinoline sulphate; Gliocladium virens; guazatine; guazatine acetate; gy-81; hexachlorobenzene; hexaconazole; hymexazol; potassium hydroxyquinoline sulphate; icia 0858; ikf-916; imazalil; imazalil sulphate; imibenconazole; iprobenphos; iminoctadine; iminoctadine triacetate; iminoctadine tris[albesilate]; ipconazole; iprobenfos; iprodione; iprovalicarb; isoprothiolane; kasugamycin; kasugamycin hydrochloride hydrate; kresoxim-methyl; mancopper; mancozeb; maneb; mefenoxame; mepanipyrim; mepronil; mercury(II) chloride; mercury(II) oxide; mercury(I) chloride; metalaxyl and its enantiomers, in particular metalaxyl-m; metam; metam-sodium; metconazole; methasulfocarb; methyl isothiocyanate; metiram; metiram-zinc; metominostrobin (ssf-126); mon⁶5500; myclotbutanil; nabam; naphthenic acid; zinc naphthenate; natamycin; nickel bis(dimethyldithiocarbamate); nitrothal-isopropyl; nuarimol; octhilinone; ofurace; oleic acid (fatty acids); oxadixyl; oxine-copper; oxycarboxin; penconazole; pencycuron; pentachlorophenol; pentachlorophenyl laurate; perfurazoate; 2-phenylphenol; Phlebiopsis gigantea; phosphoric acid and its derivatives such as fosetyl-al, phthalide; picoxystrobin; piperalin; polyoxine b; polyoxines; polyoxorim; probenazole; prochloraz; procymidone; propamocarb; propamocarb hydrochloride; propiconazole; propineb; pyraclostrobin; pyrazophos; pyributicarb; pyrifenox; pyrimethanil; pyroquilon; quinoxyfen; quintozene; rh-7281; sec-butylamine; sodium 2-phenylphenoxide; sodium pentachlorophenoxide; silthiofam, simeconazole, spiroxamine (kwg 4168); Streptomyces griseoviridis; sulphur; tar oils; tebuconazole; tecnazene; tetraconazole; thiabendazole; thifluzamide; thiophanate such as thiophanate-methyl; thiram; tolclofos-methyl; tolylfluanid; triadimefon; triadimenol; trifloxystrobin; triazolopyrimidines, in particular methyl cloransulam, flumetsulam, florasulam, metosulam, triazoxide; Trichoderma harzianum; tricyclazole; tridemorph; trifloxystrobin; triflumizole; triforine; triticonazole; validamycin; valinamide derivatives, in particular iprovalicarb and benthiavalicarb; vinclozolin; zineb; ziram; zenoxamide and mixtures thereof.
